(19) United States
(12) Patent Application Publication
(10) Pub. No.: US 2014/0267132 A1
(43) Pub. Date: Sep. 18, 2014

(54) Comprehensive Framework for Adaptive Touch-Signal De-Noising/Filtering to Optimize Touch Performance

(71) Applicant: QUALCOMM MEMS Technologies. Inc., San Diego, CA (US)

(72) Inventors: Khosro M. RABII, San Diego, CA (US); Ion BITA, San Jose, CA (US)

(73) Assignee: QUALCOMM MEMS Technologies. Inc., San Diego, CA (US)

(21) Appl. No.: 13/802,479

(22) Filed: Mar. 13, 2013

(51) Int. Cl. G06F 3/041; G06F 3/044

(52) U.S. Cl. CPC G06F 3/0418; G06F 3/044
USPC 345/174; 345/173

(57) ABSTRACT

A method, an apparatus, and a computer program product for wireless communication are provided. The apparatus estimates an amount of future noise that can affect the touch screen. The apparatus alters a sensitivity of the touch screen based on the estimated amount of the future noise.

### BACKGROUND

1. Field

The present disclosure relates generally to a touch device, and more particularly, to a comprehensive framework for adaptive touch-signal de-noising/filtering to optimize touch performance.

2. Background

Devices such as computing devices, mobile devices, kiosks often employ a touch screen interface with which a user can interact with the devices by touch input (e.g., touch by a user or an input tool such as a pen). Touch screen devices employing the touch screen interface provide convenience to users, as the users can directly interact with the touch screen. The touch screen devices receive the touch input, and execute various operations based on the touch input. For example, a user may touch an icon displayed on the touch screen to execute a software application associated with the icon, or a user may draw on the touch screen to create drawings. The user may also drag and drop items on the touch screen or may pan a view on the touch screen with two fingers. Thus, a touch screen device that is capable of accurately analyzing the touch input on the touch screen is needed to accurately execute desired operations. Various factors such as noise may affect performance of the touch screen, and may affect accuracy of the operation of the touch screen device. Therefore, a touch screen device that compensates for the noise and/or other conditions that affect the touch screen device is desired in order to improve accuracy of the touch screen operations.

### SUMMARY

In an aspect of the disclosure, a method, a computer program product, and an apparatus are provided. The apparatus estimates an amount of future noise that can affect the touch screen. The apparatus alters a sensitivity of the touch screen based on the estimated amount of the future noise.

To estimate the amount of the future noise, the apparatus may determine a characteristic of an image displayed on the touch screen and may estimate the amount of the future noise based on the determined characteristic of the displayed image. The characteristic of the image may include at least one of a dynamicity of the image indicating a degree of motion in the image and content of the image.

The amount of the future noise may be estimated for each of a plurality of regions in the touch screen, and the sensitivity of the touch screen corresponding to each of the plurality of regions may be altered based on the amount of the future noise in each of the plurality of regions.

The sensitivity may be altered when the estimated amount of the future noise is greater than a first threshold or less than a second threshold. The sensitivity may be increased when the estimated amount of the future noise is less than the second threshold and may be decreased when the estimated amount of the future noise is greater than the first threshold. The sensitivity may be decreased when the estimated amount of the future noise is less than the second threshold and may be increased when the estimated amount of the future noise is greater than the first threshold. To alter the sensitivity of the touch screen, the apparatus may decrease the sensitivity if the amount of the future noise increases and may increase the sensitivity if the amount of the future noise decreases. To alter the sensitivity of the touch screen, the apparatus may alter a capacitance of the touch screen.

The amount of the future noise may be estimated based on at least one of a supply regulator noise, a use noise, a use-environment noise, a processing performance noise, or a display noise. The amount of the future noise may be estimated based on the supply regulator noise, the supply regulator noise including a noise caused by at least one of a battery condition, a grounding condition, electrostatic discharge, electromagnetic interference, or an external electrical noise. The amount of the future noise may be estimated based on the use noise, the use noise including a noise caused by at least one of a touch-stability condition, a through-touch condition, or a touch-screen surface condition. The amount of the future noise may be estimated based on the use-environment noise, the use-environment noise including a noise caused by at least one of a temperature condition, a moisture condition, a lighting condition, an altitude, or an air quality condition. The amount of the future noise may be estimated based on the processing performance noise, the processing performance noise including a noise caused by at least one of real-time characteristics for touch screen processing or stability calibrations. The amount of the future noise may be estimated based on the display noise, the display noise including a noise caused by at least one of a reflective display, a non-emissive/transmissive display, or an emissive-luminescent display.

The apparatus may alter the sensitivity of the touch screen further based on parameters of a touch manager and parameters of a display manager. The parameters of the touch manager may include a touch medium size and a touch window, and the parameters of the display manager may include display specifications and display-content characteristics.

The future noise may be generated by a display module and the touch screen may be within the display module.

### BRIEF DESCRIPTION OF THE DRAWINGS

FIG. 1 is a diagram illustrating an example of a touch screen device.

FIG. 2 is a diagram illustrating an example of mobile device architecture with a touch screen display and an external display device.

FIG. 3 is a diagram illustrating an example of a mobile touch screen device with a touch screen controller.

FIG. 4 illustrates an example of a capacitive touch processing data path in a touch screen device.

FIGS. 5A-5C illustrate examples of measurement approaches to sense touching on the touch screen.

FIGS. 6A-6D illustrate examples different types of display stackup configurations.

FIGS. 7A and 7B illustrate an example of the in-cell configuration.

FIG. 8 illustrates a closer look at display and touch subsystems in mobile-handset architecture.

FIG. 9 illustrates an exemplary embodiment of a touch screen device with a comprehensive touch-signal conditioning framework with touch screen sensitivity adjustment.

FIGS. 10A-10C illustrate exemplary embodiments of the touch screen control with touch screen sensitivity adjustment in various touch screen devices.

FIG. 11 is a flow chart of a method of touch screen sensitivity adjustment.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of touch screen devices will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Touch screen technology enables various types of uses. As discussed supra, a user may touch a touch screen to execute various operations such as execution of an application. In one example, the touch screen provides a user interface with a direct touch such as a virtual-keyboard and user-directed controls. The user interface with the touch screen may provide proximity detection. The user may hand-write on the touch screen. In another example, the touch screen technology may be used for security features, such as surveillance, intrusion detection and authentication, and may be used for a use-environment control such as a lighting control and an appliance control. In another example, the touch screen technology may be used for healthcare applications (e.g., a remote sensing environment, prognosis and diagnosis).

Several types of touch screen technology are available today, with different designs, resolutions, sizes, etc. Examples of the touch screen technology with lower resolution include acoustic pulse recognition (APR), dispersive signal technology (DST), surface acoustic wave (SAW), traditional infrared (IR/NIR), waveguide infrared, optical, and force-sensing. A typical mobile device includes a capacitive touch screen (e.g., mutual projective-capacitance touch screen), which allows for higher resolution and a thin size of the screen. Further, a capacitive touch screen provides good accuracy, good linearity and good response time, as well as relatively low chances of false negatives and false positives. Therefore, the capacitive touch screen is widely used in mobile devices such as mobile phones and tablets. Examples of a capacitive touch screen used in mobile devices include an in-cell touch screen and an on-cell touch screen, which are discussed infra.

FIG. 1 is a diagram illustrating an example of a touch screen user equipment (UE) 100. The touch screen UE 100 may be a computer, a monitor, or a mobile device such as a mobile phone or a tablet. As illustrated in FIG. 1, the touch screen UE 100 includes a device main body 102, a touch screen 104, and a sensor 106 on the main body 102. The sensor 106 may include one or more of a temperature sensor, a humidity sensor, an accelerometer, a light sensor, a sound sensor, a Global Positioning System (GPS) sensor, or another type of sensor. The touch screen 104 may display an executed application such as a media player application 110. The media player application 110 has a media screen 112 that can display a still image or a movie and also has selectable buttons 114, 116, and 118 that are selectable by a user touch on the touch screen 104. The touch screen 104 may display application icons 122, 124, and 126 that are selectable by a user touch.

FIG. 2 is a diagram illustrating an example of mobile device architecture 200 with a touch screen display and an external display device. In this example, the mobile device architecture 200 includes an application processor 202, a cache 204, an external memory 206, a general-purpose graphics processing unit (GPGPU) 208, an application data mover 210, an on-chip memory 212 that is coupled to the application data mover 210 and the GPGPU 208, and a multispectral multiview imaging core, correction/optimization/enhancement, multimedia processors and accelerators component 214 that is coupled to the on-chip memory 212. The application processor 202 communicates with the cache 204, the external memory 206, the GPGPU 208, the on-chip memory 212, and the multispectral multiview imaging core, correction/optimization/enhancement, multimedia processors and accelerators component 214. The mobile device architecture 200 further includes an audio codec, microphones, headphone/earphone, and speaker component 216, a display processor and controller component 218, and a display/touch panels with drivers and controllers component 220 coupled to the display processor and controller component 218. The mobile architecture 200 may optionally include an external interface bridge (e.g., a docking station) 222 coupled to the display processor and controller component 218, and an external display 224 coupled to the external interface bridge 222. The external display 224 may be coupled to the external interface bridge 222 via a wireless-display connection 226 or a wired connection, such as a high-definition multimedia interface (HDMI) connection. The mobile device architecture 200 further includes a connection processor 228 coupled to a 3G/4G modem 230, a Wi-Fi modem 232, a GPS sensor 234, and a Bluetooth module 236. The mobile device architecture 200 also includes peripheral devices and interfaces 238 that communicate with an external storage module 240, the connection processor 228, and the external memory 206. The mobile device architecture also includes a security component 242. The external memory 206 is coupled to the GPGPU 208, the application data mover 210, the display processor and controller 218, the audio codec, microphones, headphone/earphone and speaker component 216, the connection processor 228, the peripheral devices and interfaces 238, and the security component 242.

The mobile device architecture 200 further includes a battery monitor and platform resource/power manager component 244 that is coupled to a battery charging circuit and power manager component 248 and to temperature compensated crystal oscillators (TCXOs), phase-lock loops (PLLs), and clock generators component 246. The battery monitor and platform resource/power manager component 244 is also coupled to the application processor 202. The mobile device architecture 200 further includes sensors and user-interface devices component 248 coupled to the application processor 202, and includes light emitters 250 and image sensors 252 coupled to the application processor 202. The image sensors 252 are also coupled to the multispectral multiview imaging core, correction/optimization/enhancement, multimedia processors and accelerators component 214.

FIG. 3 is a diagram illustrating an example of a mobile touch screen device 300 with a touch screen controller. The mobile touch screen device 300 includes a touch screen display unit 302 and a touch screen subsystem with a standalone touch screen controller 304 that are coupled to a multi-core application-processor subsystem with High Level Output Specification (HLOS) 306. The touch screen display unit 302 includes a touch screen panel and interface unit 308, a display driver and panel unit 310, and a display interface 312. The display interface 312 is coupled to the display driver and panel 310 and the multi-core application-processor subsystem with HLOS 306. The touch screen panel and interface unit 308 receives a touch input via a user touch, and the display driver and panel unit 310 displays an image. The touch screen subsystem 304 includes an analog front end 314, a touch activity and status detection unit 316, an interrupt generator 318, a touch processor and decoder unit 320, clocks and timing circuitry 322, and a host interface 324. The analog front end 314 communicates with the touch screen panel and interface 308 to receive an analog touch signal based on a user touch on the touch screen, and may convert the analog touch signal to a digital touch signal to create touch signal raw data. The analog front end 314 may include row/column drivers and an analog-to-digital converter (ADC).

The touch activity and status detection unit 316 receives the touch signal from the analog front end 314 and then communicates to the interrupt generator 318 of the presence of the user touch, such that the interrupt generator 318 communicates a trigger signal to the touch processor and decoder unit 320. When the touch processor and decoder unit 320 receives the trigger signal from the interrupt generator 318, the touch processor and decoder 320 receives the touch signal raw data from the analog front end 314 and processes the touch signal raw data to create touch data. The touch processor and decoder 320 sends the touch data to the host interface 324, and then the host interface 324 forwards the touch data to the multi-core application processor subsystem 306. The touch processor and decoder 320 is also coupled to the clocks and timing circuitry 322 that communicates with the analog front end 314.

The mobile touch screen device 300 also includes a display-processor and controller unit 326 that sends information to the display interface 312, and is coupled to the multi-core application processor subsystem 306. The mobile touch screen device 300 further includes an on-chip and external memory 328, an application data mover 330, a multimedia and graphics processing unit (GPU) 332, and other sensor systems 334, which are coupled to the multi-core application processor subsystem 306. The on-chip and external memory 328 is coupled to the display processor and controller unit 326 and the application data mover 330. The application data mover 330 is also coupled to the multimedia and graphics processing unit 332.

FIG. 4 illustrates an example of a capacitive touch processing data path in a touch screen device 400. The touch screen device 400 has a touch scan control unit 402 that is coupled to drive control circuitry 404, which receives a drive signal from a power management integrated circuit (PMIC) and touch-sense drive supply unit 406. The drive control circuitry 404 is coupled to a top electrode 408. The capacitive touch screen includes two sets of electrodes, where the first set includes the top electrode 408 (or an exciter/driver electrode) and the second set includes a bottom electrode 410 (or a sensor electrode). The top electrode 408 is coupled to the bottom electrode 410 with capacitance between the top electrode 408 and the bottom electrode 410. The capacitance between the top electrode 408 and the bottom electrode 410 includes an electrode capacitance (c_{electrode}) 412, a mutual capacitance (cₘᵤₜᵤₐₗ) 414, and a touch capacitance (c_{touch}) 416. A user touch capacitance (C_{TOUCH}) 418 may form when there is a user touch on the top electrode 408 of the touch screen. With the user touch on the top electrode 408, the user touch capacitance 418 induces capacitance on the top electrode 408, thus creating a new discharge path for the top electrode 408 through the user touch. For example, before a user's finger touches the top electrode 408, the electrical charge available on the top electrode 408 is routed to the bottom electrode 410. A user touch on a touch screen creates a discharge path through the user touch, thus changing a discharge rate of the charge at the touch screen by introducing the user touch capacitance 418. The user touch capacitance 418 created by a user touch may be far greater than capacitances between the top electrode 408 and the bottom electrode 410 (e.g., the electrode capacitance 412, the mutual capacitance 414, and the touch capacitance 416), and thus may preempt the other capacitances (e.g., c_{electrode} 412, cₘᵤₜᵤₐₗ 414, and c_{touch} 416) between the top electrode 408 and the bottom electrode 410.

The bottom electrode 410 is coupled to charge control circuitry 420. The charge control circuitry 420 controls a touch signal received from the top and bottom electrodes 408 and 410, and sends the controlled signal to a touch conversion unit 422, which converts the controlled signal to a proper signal for quantization. The touch conversion unit 422 sends the converted signal to the touch quantization unit 424 for quantization of the converted signal. The touch conversion unit 422 and the touch quantization unit 424 are also coupled to the touch scan control unit 402. The touch quantization unit 424 sends the quantized signal to a filtering/de-noising unit 426. After filtering/de-noising of the quantized signal at the filtering/de-noising unit 426, the filtering/de-noising unit 426 sends the resulting signal to a sense compensation unit 428 and a touch processor and decoder unit 430. The sense compensation unit 428 uses the signal from the filtering/de-noising unit 426 to perform sense compensation and provide a sense compensation signal to the charge control circuitry 420. In other words, the sense compensation unit 428 is used to adjust the sensitivity of the touch sensing at the top and bottom electrodes 408 and 410 via the charge control circuitry 420.

The touch processor and decoder unit 430 communicates with clocks and timing circuitry 438, which communicates with the touch screen control unit 402. The touch processor and decoder unit 430 includes a touch reference estimation, a baselining, and adaptation unit 432 that receives the resulting signal from the filtering/de-noising unit 426, a touch-event detection and segmentation unit 434, and a touch coordinate and size calculation unit 436. The touch reference estimation, baselining, and adaptation unit 432 is coupled to the touch-event detection and segmentation unit 434, which is coupled to the touch coordinate and size calculation unit 436. The touch processor and decoder unit 430 also communicates with a small co-processor/multi-core application processor 440 with HLOS, which includes a touch primitive detection unit 442, a touch primitive tracking unit 444, and a symbol ID and gesture recognition unit 446. The touch primitive detection unit 442 receives a signal from the touch coordinate and size calculation unit 436 to perform touch primitive detection, and then the touch primitive tracking unit 444 coupled to the touch primitive detection unit 442 performs the touch primitive tracking. The symbol ID and gesture recognition unit 446 coupled to the touch primitive tracking unit 444 performs recognition of a symbol ID and/or gesture.

Various touch sensing techniques are used in the touch screen technology. Touch capacitance sensing techniques may include e-field sensing, charge transfer, force-sensing resistor, relaxation oscillator, capacitance-to-digital conversion (CDC), a dual ramp, sigma-delta modulation, and successive approximation with single-slope ADC. The touch capacitance sensing techniques used in today's projected-capacitance (P-CAP) touch screen controller include a frequency-based touch-capacitance measurement, a time-based touch-capacitance measurement, and a voltage-based touch-capacitance measurement.

In the frequency-based measurement, a touch capacitor is used to create an RC oscillator, and then a time constant, a frequency, and/or a period are measured. The frequency-based measurement includes a first method using a relaxation oscillator, a second method using frequency modulation and a third method a synchronous demodulator. The first method using the relaxation oscillator uses a sensor capacitor as a timing element in an oscillator. In the second method using the frequency modulation, a capacitive sensing module uses a constant current source/sink to control an oscillator frequency. The third method using the synchronous demodulator measures a capacitor's AC impedance by exciting the capacitance with a sine-wave source and measuring a capacitor's current and voltage with a synchronous demodulator four-wire ratiometric coupled to the capacitor.

The time-based measurement measures charge/discharge time dependent on touch capacitance. The time-based measurement includes methods using resistor capacitor charge timing, charge transfer, and capacitor charge timing using a successive approximation register (SAR). The method using resistor capacitor charge timing measures sensor capacitor charge/discharge time for with a constant voltage. In the method using charge transfer, charging the sensor capacitor and integrating the charge over several cycles, ADC or comparison to a reference voltage, determines charge time. Many charge transfer techniques resemble sigma-delta ADC. In the method using capacitor charge timing using the SAR, varying the current through the sensor capacitor, matches a reference ramp.

The voltage-based measurement monitors a magnitude of a voltage to sense user touch. The voltage-based measurement includes methods using a charge time measuring unit, a charge voltage measuring unit, and a capacitance voltage divide. The method using the charge time measuring unit charges a touch capacitor with a constant current source, and measures the time to reach a voltage threshold. The method using the charge voltage measuring unit charges the capacitor from a constant current source for a known time and measures the voltage across the capacitor. The method using the charge voltage measuring unit requires a very low current, high-precision current source, and high-impedance input to measure the voltage. The method using the capacitance voltage divide uses a charge amplifier that converts the ratio of the sensor capacitor to a reference capacitor into a voltage (Capacitive-Voltage-Divide). The method using the capacitance voltage divide is the most common method for interfacing to precision low-capacitance sensors.

FIGS. 5A-5C illustrate examples of measurement approaches to sense touching on the touch screen. FIG. 5A illustrates an exemplary approach of a frequency-based touch-capacitance measurement 500. The frequency-based touch-capacitance measurement may be implemented with a relaxation oscillator, where the relaxation oscillator operates at a different frequency when there is a user touch. A reset period 502 is a time period before a touch screen is activated to sense a user touch, and a recovery period 508 is a time period after a user touch is removed. As illustrated in FIG. 5A, the frequency during the sense time 504 and a decision time 506 are different from the frequency during the reset period 502 and the recovery period 508. A decision as to whether the user touch is sensed is made at a decision time 506. Because introducing a user touch on the touch screen changes the discharge rate, the relaxation oscillator may have a changed RC or LC component during the user touch, which results in a different frequency during the sense time 504 and the decision time 506 than the reset period and the recovery period 508.

FIG. 5B illustrates an exemplary approach of a time-based touch-capacitance measurement 520 that monitors a discharge rate, where a discharge rate over time changes when there is a user touch. A reset period 522 is a time period before a touch screen is activated to sense a user touch, and a recovery period 528 is a time period after a user touch is removed. After the touch screen is activated, the voltage starts increasing as the touch screen is charged during the first portion of the sense time 524. When there is a user touch on the touch screen, the voltage at the touch screen discharges at a faster rate (a dotted line) than when there is no user touch (a solid line), during the sense time 524. Thus, the faster discharge rate may indicate a user touch. The decision time 526 may overlap with the sense time 524, and a decision as to whether the user touch is sensed is made at a decision time 526. As discussed supra, the discharge rate changes with a user touch because a user touch on the touch screen creates a new discharge path through the user touch. FIG. 5C illustrates an exemplary approach of a voltage-based touch-capacitance measurement 540, where a voltage change indicates a presence of a user touch. A reset period 542 is a time period before a touch screen is activated to sense a user touch, and a recovery period 548 is a time period after a user touch is removed. The voltage at the touch screen increases as the capacitor in the touch screen is charged during a sense time 544. During a decision time 546, the voltage at the touch screen remains constant. A decision as to whether the user touch is sensed is made at a decision time 546. When there is a user touch on the touch screen, the voltage is charged at a lower rate (a dotted line) and thus a lower voltage results than in the absence of a user touch (a solid line). Thus, a lower voltage may indicate a user touch. The user touch creates a discharge path via the user touch, and thus less voltage is charged with the user touch.

FIGS. 6A-6D illustrate examples of different types of display stackup configurations. FIG. 6A illustrates a first example of an out-cell display stackup configuration 600. In the first out-cell display stackup configuration 600, a display substrate 602, a color-filter 604, a polarizer 606, a discrete-sensor 608, and a lens 610 are sequentially stacked on top of one another, as illustrated in FIG. 6A. In the first out-cell display stackup configuration 600, top electrodes 612 and bottom electrodes 614 are located on the same side of the discrete-sensor 608. FIG. 6B illustrates a second example of an out-cell display stackup configuration 620. In the second out-cell display stackup configuration 620, a display substrate 622, a color-filter 624, a polarizer 626, a discrete-sensor 628, and a lens 630 are sequentially stacked on top of one another, as illustrated in FIG. 6B. In the second out-cell display stackup configuration 600, top electrodes 632 are located on one side of the discrete-sensor 628, and bottom electrodes 634 are located on the other side of discrete-sensor 628.

FIG. 6C illustrates an example of an on-cell display stackup configuration. In the on-cell display stackup configuration 640, a display substrate 642, a color-filter 644, a polarizer 646, and a lens 650 are sequentially stacked on top of one another, as illustrated in FIG. 6C. In the on-cell display stackup configuration 640, top electrodes 652 and bottom electrodes 654 are located on the bottom surface of the color filter 644. Thus, the discrete-sensor 648 is not needed in the on-cell display stackup configuration 640, and the lens 650 can be placed on the polarizer 646. Because the distance between the bottom electrodes 654 and the display substrate 642 in the out-cell configuration of FIG. C is less than the distance between the bottom electrodes and the display substrate in the out-cell configurations of FIGS. 6A and 6B, display conditions or display noise has a greater effect on the on-cell configuration than on the out-cell configurations.

FIG. 6D illustrates an example of an in-cell display stackup configuration 660. In the in-cell display stackup configuration 660, a display substrate 662, a color-filter 664, a polarizer 666, and a lens 670 are sequentially stacked on top of one another, as illustrated in FIG. 6D. In the in-cell display stackup configuration 660, top electrodes 672 and bottom electrodes 674 are located within the display substrate 662. Thus, the discrete-sensor 668 is not needed in the in-cell display stackup configuration 660, and the lens 670 can be placed on the polarizer 666. The in-cell configuration provides a thin configuration, but introduces a lot of noise to the bottom electrodes 674. For instance, because the bottom electrodes 674 are embedded within the display substrate 662, a display noise from the display substrate 662 has a greater effect on the bottom electrodes 674 in the in-cell configuration 660 than the other configurations (e.g., out-cell configurations and on-cell configuration) that have the bottom electrodes spaced apart from the display substrate.

FIGS. 7A-7B illustrate an example of the in-cell configuration. FIG. 7A illustrates an example of a touch screen structure 700 with electrodes. In FIG. 7A, a magnified view 720 is a magnification of a circular region 712 in a pan-out view 710. The magnified view 720 illustrates top electrodes 722 and bottom electrodes 724 arranged in a tile-like manner on a touch screen display. The top electrodes 722 and the bottom electrodes 724 may be embedded in a display substrate, as discussed supra. FIG. 7B illustrates an example of a touch screen structure 740 with electrodes and display pixels. As illustrated in FIG. 7B, a magnified view 760 of a touch screen display 750 illustrates that each display pixel 762 may have a corresponding bottom electrode (a touch sensor) 764 embedded therein.

FIG. 8 illustrates a closer look at display and touch subsystems in mobile-handset architecture. The mobile handset 800 includes a touch screen display unit 802, a touch screen controller 804, and a multi-core application processor subsystem with HLOS 806. The touch screen display unit 802 includes a touch panel module (TPM) unit 808 coupled to the touch screen controller 804, a display driver 810, and a display panel 812 that is coupled to the display driver 810. The mobile handset 800 also includes a system memory 814, and further includes a user-applications and 2D/3D graphics/graphical effects (GFX) engines unit 816, a multimedia video, camera/vision engines/processor unit 818, and a downstream display scaler 820 that are coupled to the system memory 814. The user-applications and 2D/3D GFX engines unit 816 communicates with a display overlay/compositor 822, which communicates with a display-video analysis unit 824. The display-video analysis unit 824 communicates with a display-dependent optimization and refresh control unit 826, which communicates with a display controller and interface unit 828. The display controller and interface unit 828 communicates with the display driver 810. The multimedia video, camera/vision engines/processor unit 818 communicates with a frame-rate-upconverter (FRU), de-interlace, scaling/rotation component 830, which communicates with the display overlay/compositor 822. The downstream display scaler 820 communicates with a downstream display overlay/compositor 832, which communicates with a downstream display processor/encoder unit 834. The downstream display processor/encoder unit 834 communicates with a wired/wireless display interface 836. The multi-core application processor subsystem with HLOS 806 communicates with the display-video analysis unit 824, the display-dependent optimization and refresh control unit 826, the display controller and interface unit 828, the FRU, de-interlace, scaling/rotation component 830, the downstream display overlay/compositor 832, the downstream display processor/encoder unit 834, and the wired/wireless display interface 836. The mobile handset 800 also includes a battery management system (BMS) and PMIC unit 838 coupled to the display driver 810, the touch-screen controller 804, and the multi-core application processor subsystem with HLOS 806.

There are known challenges for accurate sensing of touch in the touch screen. For example, a touch-capacitance can be small, depending on a touch-medium. The touch capacitance is sensed over high output impedance. Further, a touch transducer often operates in platforms with a large parasitic and noisy environment. In addition, touch transducer operation can be skewed with offsets and its dynamic range may be limited by a DC bias.

Several factors may affect touch screen signal quality. On the touch screen panel, the signal quality may be affected by a touch-sense type, resolution, a touch sensor size, fill factor, touch panel module integration configuration (e.g., out-cell, on-cell, in-cell, etc.), and a scan overhead. A type of a touch-medium such as a hand/finger or stylus and a size of touch as well as responsivity such as touch-sense efficiency and a transconductance gain may affect the signal quality. Further, sensitivity, linearity, dynamic range, and a saturation level may affect the signal quality. In addition, noises such as no-touch signal noise (e.g. thermal and substrate noise), a fixed-pattern noise (e.g., touch panel spatial non-uniformity), and a temporal noise (e.g., EMI/RFI, supply noise, display noise, use noise, use-environment noise) may affect the signal quality.

One approach commonly used to optimize a signal-to-noise ratio (SNR) of a touch signal is improving design robustness by minimizing stray capacitance, avoiding conductive overlays that span beyond a sensor panel, maximizing a sensor size and proximity to neighboring sensors, minimizing overlay thicknesses, and minimizing air-gaps in a TPM stackup. Another approach commonly used to optimize the SNR of the touch signal is baselining. The baselining approach considers TPM stackup specifications, use-environment characteristics, a platform context, and touch transducer and converter performance. The TPM stackup specification includes information on out-cell/on-cell/in-cell & display-type, touch screen controller (TSC) location (printed circuit board (PCB), flex, substrate, or glass), overlay non-uniformity, air-gap, and adhesive. The use-environment characteristics include contaminants, temperature, humidity, ambient-lighting. The platform context includes battery state-of-charge/state-of-voltage (SOC/SOV) and device kinetics (e.g., an accelerometer, a gyroscope). The state-of-charge may indicate how the battery is charging and may be used to estimate when the battery can reach a “FULL” status. The state-of-voltage may indicate the battery capacity (e.g., how much charge/battery-reserve the battery has), and may depend on a battery type. The touch transducer and converter performance includes sensitivity, saturation level, dynamic range, and linearity.

When a high motion video content is displayed, then the motion in the video content may create noise that affects the bottom electrodes, thus affecting the touch screen. In the out-cell display stackup configuration, there is a discrete sensor layer to hold the top and bottom electrodes. However, because the on-cell and in-cell configurations do not have a separate discrete sensor layer to hold the top and bottom electrodes, the noise can affect the top and bottom electrodes of the on-cell and in-cell configurations more easily than those of the out-cell configuration. Further, because minimizing a thickness of a display stackup is desired, in order to provide a thin mobile device, on-cell and in-cell configurations that provide the desired thickness are widely used. Therefore, improving a touch sensing experience by taking into account the display noise is desired in the on-cell and in-cell configurations.

There are several approaches to minimize display noise in a touch signal. The first approach is halting a display refresh when sensing a user touch (i.e., frame-stealing). For example, with a 100 Hz refresh rate (mainly for a 3D-display), scanning 2000 nodes of a large touch-panel in a single frame time requires a 200 kHz touch scan rate. Depending on noise, 2×-4× overscan overhead for correlated sampling (de-noising/filtering) increases an actual touch scan rate to approximately 1 MHz. However, touch processing overhead (MIPS & memory-throughput) at such high scan rates minimizes battery cycle-life. Further, the first approach is intrusive and minimizes display performance.

The second approach is sensing a user touch during blanking-intervals. For example, depending on a blanking interval duration and the number of touch nodes scanned, this approach actually requires higher touch scan rate. To minimize battery power, touch drive voltage must be turned off during active intervals, depending on drive voltage. However, this requires a high slew-rate for turn-on, which increases noise and minimizes a battery cycle-life. Further, the display driver is generally foreign and cannot be controlled. In addition, depending on a display type and design practices (smart/dumb display), display related timing signals are often unavailable to infer blanking intervals

For at least the reasons discussed supra, an effective approach to compensate for display characteristics and other factors that can affect the touch screen sensing is desired to achieve accurate touch sensing on the touch screen.

FIG. 9 illustrates an exemplary embodiment of a touch screen device 900 with a comprehensive touch-signal conditioning framework with touch screen sensitivity adjustment. The touch screen device 900 device may have the on-cell configuration or the in-cell configuration. A touch scan control unit 902, drive control circuitry 904, a PMIC and touch-sense drive supply unit 906, a top electrode 908, a bottom electrode 910, a electrode capacitance 912, a mutual capacitance 914, a touch capacitance 916, a user touch capacitance 918, charge control circuitry 920, a touch conversion unit 922, a touch quantization unit 924, a filtering/de-noising unit 926, and a sense compensation unit 928 are equivalent to the touch scan control unit 402, the drive control circuitry 404, the PMIC and touch-sense drive supply unit 406, the top electrode 408, the bottom electrode 410, the electrode capacitance 412, the mutual capacitance 414, the touch capacitance 416, the user touch capacitance 418, the charge control circuitry 420, the touch conversion unit 422, the touch quantization unit 424, and the filtering/de-noising unit 426, and the sense compensation unit 428 of FIG. 4 respectively. A touch processor and decoder unit 930 including a touch reference estimation, baselining, and adaptation unit 932, a touch-event detection and segmentation unit 934, and a touch coordinate and size calculation unit 936 are equivalent to the touch processor and decoder unit 430 including the touch reference estimation, baselining and adaptation unit 432, the touch-event detection and segmentation unit 434, and the touch coordinate and size calculation unit 436 of FIG. 4, respectively. Thus, description of the units 902-936 in FIG. 9 is omitted.

The touch processor and decoder unit 930 communicates with a small co-processor/multi-core application processor 940 with HLOS. The small co-processor/multi-core application processor with HLOS 940 includes a touch primitive detection unit 942, a touch primitive tracking unit 944, and a symbol ID and gesture recognition unit 946. The features of the touch primitive detection unit 942, the touch primitive tracking unit 944, and the symbol ID and gesture recognition unit 946 are similar to the features of the touch primitive detection unit 442, the touch primitive tracking unit 444, and the symbol ID and gesture recognition unit 446 of FIG. 4. The small co-processor/multi-core application processor with HLOS 940 further includes a calibration unit 948 and a display tile-data direct memory access (DMA) and processing unit 950. The small co-processor/multi-core application processor with HLOS 940 is also coupled to a display-processor and controller unit 952 and other sensory systems 954. With the display information from the display-processor and controller unit 952, the display tile-data DMA and processing unit 950 may provide image characteristics to the calibration unit 948. The calibration unit 948 may also receive information from the other sensory systems 954.

The calibration unit 948 is used to predict noise that can affect the touch screen based on information about the image characteristics received from the display-processor and controller unit 952 and/or the information from the other sensory systems 954. The calibration unit 948 is also used to adjust the sensitivity of the touch screen sensing by sending a calibration signal to the charge control circuitry 920 via the sense compensation unit 928 based on the predicted noise. The calibration unit 948 can be used to adjust the sensitivity based on various factors such as display conditions and noise that can affect the touch screen. For example, when a lot of noise is anticipated at the touch screen, then the calibration unit 948 may lower the sensitivity of the touch screen such that false touches will not be detected by the touch screen. The sensitivity of the electrodes may be changed by changing a magnitude of the capacitance between the top and bottom electrodes 908 and 910 (e.g., the electrode capacitance 912, the mutual capacitance 914, and/or the touch capacitance 916).

The calibration unit 948 may adjust the sensitivity by region of the touch screen. For example, if a lot of noise is expected in a top-left corner region of the touch screen, the calibration unit 948 may adjust the sensitivity of the electrodes in the top-left corner region of the touch screen. As another example, a region of the touch screen that is closer to a heat-generating component (e.g., a processor, a Wi-Fi chip, etc.), then such region will have a higher temperature than other regions of the touch screen. In this example, the calibration unit 948 may adjust the sensitivity of the region that has a higher temperature differently than other regions of the touch screen.

The calibration unit 948 may adjust sensitivity if the amount of predicted noise falls within a predetermined range. In the first approach, even in the presence of noise that can affect the touch screen, the calibration unit 948 may not adjust the sensitivity if the noise level is outside an acceptable range. In the second approach, the predetermined range may be undefined such that the calibration unit 948 may adjust sensitivity whenever noise and/or other factors that can affect the touch screen are present.

In the first approach, the acceptable range may be defined by a top threshold and a bottom threshold, and if the amount of the predicted noise is greater than the top threshold and less than the bottom threshold, the calibration unit 948 may adjust the sensitivity. In one touch screen type, the calibration unit 948 may increase the sensitivity when the amount of the predicted noise is less than the bottom threshold, and may decrease the sensitivity when the amount of the predicted noise is greater than the top threshold. In another touch screen type, the calibration unit 948 may decrease the sensitivity when the amount of the predicted noise is less than the bottom threshold, and may increase the sensitivity when the amount of the predicted noise is greater than the top threshold. In another example, the calibration unit 948 may decrease the sensitivity if the amount of the predicted noise increases, and may increase the sensitivity if the amount of the predicted noise decreases. Thus, the sensitivity adjustment may depend on the type of the touch screen.

A touch manager may be included in the touch processor and decoder unit 930, and a display manager may be included in the small co-processor/multi-core application processor with HLOS 940. The calibration unit 948 may adjust the sensitivity of the touch sensing based on the touch manager parameters and the display manager parameters. The touch manager may send touch manager parameters to the display manager. The touch manager parameters may include a touch-medium size, a touch window (e.g., location identifier, coordinates, and a size of the window), and TPM specifications (e.g., a pattern of a sensor and a sensor size). In return, the display manager may send display manager parameters such as display specifications and display content characteristics to the touch manager. The display specification includes a display type, a refresh rate, a display drive supply voltage, and brightness. The display content characteristics may be tile-based, and may include a tile size, dynamic range, and a picture type (e.g., static picture/dynamic picture and a rate of change in the picture).

The calibration unit 948 may adjust the sensitivity based on various characteristics of an image that is displayed on the touch screen. The characteristics of the image may include dynamicity and a content of the image. The image may have different dynamicity in that the image may be a still image, a slow motion video image, or a fast motion video image. The fast motion video image generally affects the sensitivity of the touch screen more than the still image or the slow motion video image. The image content may include information on color of the image that may affect the sensitivity of the touch screen. For example, a dark color may affect the sensitivity differently than a lighter color.

For example, referring back to FIG. 1, the screen 112 plays a fast motion video image such as sports, while the selectable buttons 114, 116, and 118 and the icons 122, 124, and 126 display corresponding still images. Therefore, the portion of the touch screen 104 with the screen 112 playing a fast motion video image may need more sensitivity adjustments than the portions of the touch screen 104 with the selectable buttons 114, 116, and 118 and the icons 122, 124, and 126. For example, in the region of the fast motion video image, the sensitivity may be lowered so that the interference by the fast motion video image may not be falsely detected as a touch signal. Different colors of the image may affect the sensitivity of the touch screen differently. Referring back to FIG. 1, the selectable buttons 114, 116, and 118 are in black and the icons 122, 124, and 126 are in a lighter color, and thus the portions of the touch screen 104 with the selectable buttons 114, 116, and 118 in black may need more sensitivity compensation than the portions of the touch screen 104 with the icons 122, 124, and 126.

The content of the image to be displayed in various portions of the touch screen may be known to the touch screen device 900 before the image is displayed because the device generates the content of the image before displaying the content of the image on the touch screen. Hence, the touch screen device 900 can anticipate what type of image will be displayed in various portions of the touch screen. Based on the anticipation, the touch screen device 900 predicts the amount of the noise to be generated at the touch sensor, and change the sensitivity of the touch screen based on the prediction of the amount of the noise that can affect the touch screen.

The calibration unit 948 may adjust the sensitivity based on noises other than the image characteristics. The other sensory systems 954 may collect information about the noises other than the image characteristics, and provide such information to the calibration unit 948 for adjustments in the touch screen sensitivity. The types of noises that can affect the touch screen sensitivity include a supply regulator noise, a use noise, a use-environment noise, a processing performance noise, and a display noise. The supply regulator noise can be caused by a low battery, a poor grounding, electrostatic discharge (ESD), electromagnetic interference/radio frequency interference (EMI/RFI), or an external electrical noise such as a noise from a mobile device battery charger. For example, the supply regulator noise may be noise induced in a power supply (e.g., touch-transducer ground and drive supply). The use noise is a type of noise that is induced by use of the device. The use noise includes a noise caused by at least one of a touch-stability condition (e.g., affected by shock or vibration, in-vehicle use, and hand-jitter), a through-touch condition (e.g., when touched with a finger nail or through a glove), or a touch-screen surface condition (e.g. affected by screen contaminants, scratch/defect). The use-environment noise is a type of noise that is induced by the environment when the device is used. The use-environment noise includes a noise caused by at least one of a temperature condition, a moisture condition, a lighting condition, an altitude, or an air quality condition (e.g., affected by dust and air particles). The process performance noise is affected by processing conditions related to the touch screen. The processing performance noise includes a noise caused by at least one of real-time characteristics for touch screen processing or stability calibrations. Display noise is a noise in a display, and may depend on the display type. The display noise includes a noise caused by at least one of a reflective display (e.g., an e-ink display), a non-emissive/transmissive display (e.g., a liquid crystal display), or an emissive-luminescent display (e.g., Active-Matrix Organic Light-Emitting Diode (AMOLED)).

FIGS. 10A-10C illustrate exemplary embodiments of the touch screen control with touch screen sensitivity adjustment in various touch screen devices. The touch screen device 1000 of FIG. 10A includes a touch screen display unit 1002 and a touch screen subsystem with a standalone touch screen controller 1004 that are coupled to a multi-core application-processor subsystem with HLOS 1006. A touch screen panel and interface unit 1008, a display driver and panel unit 1010, a display interface 1012, an analog front end 1014, a touch activity and status detection unit 1016, an interrupt generator 1018, a touch processor and decoder 1020, clocks and timing circuitry 1022, a host interface 1024, a display-processor and controller unit 1026, an on-chip and external memory 1028, an application data mover 1030, a multimedia and graphics processing unit 1032, and other sensor systems 1034 are equivalent to the touch screen panel and interface 308, the display driver and panel 310, the display interface 312, the analog front end 314, the touch activity and status detection unit 316, the interrupt generator 318, the touch processor and decoder unit 320, the clocks and timing circuitry 322, the host interface 324, the display-processor and controller unit 326, the on-chip and external memory 328, the application data mover 330, the multimedia and graphics processing unit 332, and the other sensor systems 334 of FIG. 3, respectively. Therefore, description of the units 1008-1032 is omitted. The touch processor and decoder unit 1020 receives the touch-signal raw data from the analog front end 1014 and processes the raw data to generate touch data. The touch processor and decoder unit 1020 forwards the generated touch data to the multi-core application-processor subsystem with HLOS 1006 via the host interface 1024. The touch screen device 1000 also includes a BMS and PMIC unit 1036 communicating with the multi-core application-processor subsystem with HLOS 1006.

The multi-core application-processor subsystem with HLOS 1006 includes a display tile-data access and processing unit 1042, a display-dependent optimized touch-filtering estimation unit 1044, and a calibration unit 1046. The display tile-data access and processing unit 1042 receives and processes image information about an image to be displayed from the display-processor and controller unit 1026, and forwards the processed image information to the display-dependent optimized touch-filtering estimation unit 1044 to determine sensitivity adjustments based on the display characteristics of the image. The display-dependent optimized touch-filtering estimation unit 1044 sends the sensitivity adjustment data to the calibration unit 1046, which determines sensitivity adjustments based on noise factors other than the display characteristics, such as a temperature, a battery condition, conditions and noises received from the other sensory systems 1034 and the BMS and PMIC unit 1036. The calibration unit 1046 sends the sensitivity adjustment data based on the display characteristics and/or other noise factors to the touch processor and decoder unit 1020 via the host interface 1024. The touch processor and decoder unit 1020 communicates the sensitivity adjustment to the touch screen panel and interface unit 1008 through the circuits and timing circuitry 1022 and the analog front end 1014.

In FIG. 10B, the touch screen device 1060 includes a touch screen display unit 1002 and a touch screen subsystem with a standalone touch screen controller 1004 that communicate with an application processor subsystem 1066. The application processor subsystem 1066 includes a multi-core application-processor subsystem with HLOS 1068 and a small co-processor 1070 that are coupled to each other. In particular, the multi-core application-processor subsystem with HLOS 1068 is coupled to the display interface 1012, the display processor and controller unit 1026, the on-chip and external memory 1028, the application data mover 1030, and the multimedia and GPU unit 1032. In the touch screen device 1060, the touch processor and decoder unit 1020 forwards the touch data to the small co-processor 1070. The small co-processor 1070 is coupled to the host interface 1024, the battery, the other sensory systems 1034, and the BMS and PMIC unit 1036. The small co-processor 1070 includes a display tile-data access and processing unit 1072, a display-dependent optimized touch-filtering estimation unit 1074, and a calibration unit 1076 that have features equivalent to the display tile-data access and processing unit 1042, the display-dependent optimized touch-filtering estimation unit 1044, and the calibration unit 1046 of FIG. 10A, respectively.

In FIG. 10C, the touch screen device 1080 includes a touch screen display unit 1002 and a touch screen subsystem with a standalone touch screen controller 1004 that communicate with an application processor subsystem 1086. The application processor subsystem 1086 includes a multi-core application-processor subsystem with HLOS 1088 and a small co-processor 1080 that are coupled to each other. In particular, the multi-core application-processor subsystem with HLOS 1088 is coupled to the display interface 1012, the display processor and controller unit 1026, the on-chip and external memory 1028, the application data mover 1030, and the multimedia and GPU unit 1032. The small co-processor 1090 is coupled to the host interface 1024, the battery, the other sensory systems 1034, and the BMS and PMIC unit 1036. The small co-processor 1090 includes a display tile-data access and processing unit 1092, a display-dependent optimized touch-filtering estimation unit 1094, a calibration unit 1096, and a host-based touch processor and decoder unit 1098. In the touch screen device 1080, the touch processor and decoder unit 1020 forwards the touch data to the host-based touch processor and decoder unit 1098 of the small co-processor 1090. The display tile-data access and processing unit 1092, the display-dependent optimized touch-filtering estimation unit 1094, and the calibration unit 1096 have features that are equivalent to the display tile-data access and processing unit 1042, the display-dependent optimized touch-filtering estimation unit 1044, and the calibration unit 1046 of FIG. 10A, respectively.

FIG. 11 is a flow chart 1100 of a method of touch screen sensitivity adjustment. The method may be performed by a UE. At step 1102, the UE determines a characteristic of an image displayed on the touch screen. The characteristic of an image may include dynamicity of the image indicating a degree of motion in the image and/or content of the image. For example, referring back to FIG. 9, the display tile-data DMA and processing unit 950 may provide image characteristics to the calibration unit 948, such that calibration unit 948 may adjust the sensitivity based on various characteristics of an image that is displayed on the touch screen.

At step 1104, the UE determines at least one of a supply regulator noise, a use noise, a use-environment noise, a processing performance noise, or a display noise. The supply regulator noise may include a noise caused by at least one of a battery condition, a grounding condition, electrostatic discharge, electromagnetic interference, or an external electrical noise. The use noise may include a noise caused by at least one of a touch-stability condition, a through-touch condition, or a touch-screen surface condition. The use-environment noise may include a noise caused by at least one of a temperature condition, a moisture condition, a lighting condition, an altitude, or an air quality condition. The processing performance noise may include a noise caused by at least one of real-time characteristics for touch screen processing or stability calibrations. The display noise may include a noise caused by at least one of a reflective display, a non-emissive/transmissive display, or an emissive-luminescent display. For example, referring back to FIG. 9, the other sensory systems 954 may collect information about the noises other than the image characteristics, and provide such information to the calibration unit 948 for adjustments in the touch screen sensitivity.

At step 1106, the UE estimates an amount of future noise that can affect the touch screen. The UE may estimate the amount of the future noise based on the characteristic of the image displayed on the touch screen and/or at least one of the supply regulator noise, the use noise, the use-environment noise, the processing performance noise, or the display noise. The UE may estimate the amount of the future noise for each of multiple regions in the touch screen, such that the sensitivity of the touch screen corresponding to each of the plurality of regions may be altered based on the amount of the future noise in each of the plurality of regions.

For example, referring back to FIG. 9, the calibration unit 948 is used to predict noise that can affect the touch screen based on the image characteristics and/or the information from the other sensory systems 954. As discussed supra, the calibration unit 948 may predict the future noise by considering different dynamicity because a fast motion video image generally affects the sensitivity of the touch screen more than a still image or the slow motion video image. As discussed supra, the calibration unit 948 may predict the future noise by considering the content of the image because different colors of the image may affect the sensitivity of the touch screen differently. As another example, referring back to FIG. 9, the calibration unit 948 may adjust the sensitivity by region of the touch screen. As discussed supra, if there is a lot of noise in one region of the touch screen, the calibration unit 948 may adjust the sensitivity in such region of the touch screen.

At step 1108, the UE determines whether the estimated amount of the future noise is within a predetermined range. If the UE determines that the estimated amount of the future noise is within the predetermined range, the UE alters a sensitivity of the touch screen based on the estimated amount of the future noise in step 1110. If the UE determines that the estimated amount of the future noise is not within the predetermined range, the UE may go back to step 1102. In one example approach, referring back to FIG. 9, even in the presence of noise that can affect the touch screen, the calibration unit 948 may not adjust the sensitivity if the noise level is outside an acceptable range. In another example approach, referring back to FIG. 9, the predetermined range may be undefined such that the calibration unit 948 may adjust sensitivity whenever there is noise that can affect the touch screen.

The altering of the sensitivity of the touch screen may include altering a capacitance of the touch screen. In the first approach, the sensitivity may be altered when the estimated amount of the future noise is greater than a first threshold or less than a second threshold. In one example of the first approach, the sensitivity may be increased when the estimated amount of the future noise is less than the second threshold and may be decreased when the estimated amount of the future noise is greater than the first threshold. In another example of the first approach, the sensitivity may be decreased when the estimated amount of the future noise is less than the second threshold and may be increased when the estimated amount of the future noise is greater than the first threshold. In the second approach, the altering of the sensitivity comprises decreasing the sensitivity if the amount of the future noise increases and increasing the sensitivity if the amount of the future noise decreases.

The altering of the sensitivity of the touch screen may be further based on parameters of a touch manager and parameters of a display manager. The parameters of the touch manager may include a touch medium size and a touch window, and the parameters of the display manager include display specifications and display-content characteristics. For example, referring back to FIG. 9, the touch manager may be included in the touch processor and decoder unit 930, and the display manager may be included in the small co-processor/multi-core application processor with HLOS 940, where the touch manager may send touch manager parameters to the display manager, and in return the display manager may send display manager parameters to the display manager.

The future noise may be generated by a display module, where the touch screen is within the display module. For example, referring back to FIGS. 9 and 6D, the in-cell configuration may embed the top and bottom electrodes 908 and 910 of the touch screen within the display module.

FIG. 12 is a conceptual data flow diagram 1200 illustrating the data flow between different modules/means/components in an exemplary apparatus 1202. The apparatus may be a UE. The apparatus includes a display characteristic module 1204 that determines a characteristic of an image displayed on the touch screen. The apparatus further includes a noise determination module 1206 that determines at least one of a supply regulator noise, a use noise, a use-environment noise, a processing performance noise, or a display noise. The apparatus further includes a future noise estimation module 1208 that estimates an amount of future noise that can affect the touch screen. The future noise estimation module 1208 may estimate the amount of the future noise based on the determined characteristic of the image and/or the determined at least one of a supply regulator noise, a use noise, a use-environment noise, a processing performance noise, or a display noise. The apparatus further includes a touch sensitivity control module 1210 that alters a sensitivity of the touch screen based on the estimated amount of the future noise. The apparatus further includes a touch screen module 1212 that operates the touch screen based on the altered sensitivity.

The apparatus may include additional modules that perform each of the steps of the algorithm in the aforementioned flow chart of FIG. 11. As such, each step in the aforementioned flow chart of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212 and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314. In addition, the transceiver 1310 receives information from the processing system 1314, and based on the received information, generates a signal to be applied to the one or more antennas 1320. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, 1212. The modules may be software modules running in the processor 1304, resident/stored in the computer readable medium 1306, one or more hardware modules coupled to the processor 1304, or some combination thereof.

In one configuration, the apparatus 1202/1202′ includes means for estimating an amount of future noise that can affect the touch screen, and means for altering a sensitivity of the touch screen based on the estimated amount of the future noise. The means for altering a sensitivity of the touch screen is configured to determine a characteristic of an image displayed on the touch screen, and estimate the amount of the future noise based on the determined characteristic of the displayed image. The means for altering the sensitivity is configured to decrease the sensitivity if the amount of the future noise increases and to increase the sensitivity if the amount of the future noise decreases. The means for altering the sensitivity of the touch screen is configured to alter a capacitance of the touch screen. The means for altering the sensitivity of the touch screen is configured to alter the sensitivity further based on parameters of a touch manager and parameters of a display manager. The aforementioned means may be one or more of the aforementioned modules of the apparatus 1202 and/or the processing system 1314 of the apparatus 1202′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of noise compensation in a touch screen, comprising:
estimating an amount of future noise that can affect the touch screen; and
altering a sensitivity of the touch screen based on the estimated amount of the future noise.

2. The method of claim 1, wherein the estimation of the amount of the future noise comprises:
determining a characteristic of an image displayed on the touch screen; and
estimating the amount of the future noise based on the determined characteristic of the displayed image.

3. The method of claim 2, wherein the characteristic of the image includes at least one of a dynamicity of the image indicating a degree of motion in the image and content of the image.

4. The method of claim 1, wherein the amount of the future noise is estimated for each of a plurality of regions in the touch screen, and the sensitivity of the touch screen corresponding to each of the plurality of regions is altered based on the amount of the future noise in each of the plurality of regions.

5. The method of claim 1, wherein the sensitivity is altered when the estimated amount of the future noise is greater than a first threshold or less than a second threshold.

6. The method of claim 5, wherein the sensitivity is increased when the estimated amount of the future noise is less than the second threshold and is decreased when the estimated amount of the future noise is greater than the first threshold.

7. The method of claim 5, wherein the sensitivity is decreased when the estimated amount of the future noise is less than the second threshold and is increased when the estimated amount of the future noise is greater than the first threshold.

8. The method of claim 1, wherein the altering the sensitivity comprises decreasing the sensitivity if the amount of the future noise increases and increasing the sensitivity if the amount of the future noise decreases.

9. The method of claim 1, wherein the altering the sensitivity of the touch screen includes altering a capacitance of the touch screen.

10. The method of claim 1, wherein the amount of the future noise is estimated based on at least one of a supply regulator noise, a use noise, a use-environment noise, a processing performance noise, or a display noise.

11. The method of claim 10, wherein the amount of the future noise is estimated based on the supply regulator noise, the supply regulator noise including a noise caused by at least one of a battery condition, a grounding condition, electrostatic discharge, electromagnetic interference, or an external electrical noise.

12. The method of claim 10, wherein the amount of the future noise is estimated based on the use noise, the use noise including a noise caused by at least one of a touch-stability condition, a through-touch condition, or a touch-screen surface condition.

13. The method of claim 10, wherein the amount of the future noise is estimated based on the use-environment noise, the use-environment noise including a noise caused by at least one of a temperature condition, a moisture condition, a lighting condition, an altitude, or an air quality condition.

14. The method of claim 10, wherein the amount of the future noise is estimated based on the processing performance noise, the processing performance noise including a noise caused by at least one of real-time characteristics for touch screen processing or stability calibrations.

15. The method of claim 10, wherein the amount of the future noise is estimated based on the display noise, the display noise including a noise caused by at least one of a reflective display, a non-emissive/transmissive display, or an emissive-luminescent display.

16. The method of claim 1, wherein the altering the sensitivity of the touch screen is further based on parameters of a touch manager and parameters of a display manager.

17. The method of claim 16, wherein the parameters of the touch manager include a touch medium size and a touch window, and the parameters of the display manager include display specifications and display-content characteristics.

18. The method of claim 1, wherein the future noise is generated by a display module, the touch screen being within the display module.

19. An apparatus for noise compensation in a touch screen, comprising:
means for estimating an amount of future noise that can affect the touch screen; and
means for altering a sensitivity of the touch screen based on the estimated amount of the future noise.

20. The apparatus of claim 19, wherein the means for altering a sensitivity of the touch screen is configured to:
determine a characteristic of an image displayed on the touch screen; and
estimate the amount of the future noise based on the determined characteristic of the displayed image.

21. The apparatus of claim 20, wherein the characteristic of the image includes at least one of a dynamicity of the image indicating a degree of motion in the image and content of the image.

22. The apparatus of claim 19, wherein the amount of the future noise is estimated for each of a plurality of regions in the touch screen, and the sensitivity of the touch screen corresponding to each of the plurality of regions is altered based on the amount of the future noise in each of the plurality of regions.

23. The apparatus of claim 19, wherein the sensitivity is altered when the estimated amount of the future noise is greater than a first threshold or less than a second threshold.

24. The apparatus of claim 23, wherein the sensitivity is increased when the estimated amount of the future noise is less than the second threshold and is decreased when the estimated amount of the future noise is greater than the first threshold.

25. The apparatus of claim 23, wherein the sensitivity is decreased when the estimated amount of the future noise is less than the second threshold and is increased when the estimated amount of the future noise is greater than the first threshold.

26. The apparatus of claim 19, wherein the means for altering the sensitivity is configured to decrease the sensitivity if the amount of the future noise increases and to increase the sensitivity if the amount of the future noise decreases.

27. The apparatus of claim 19, wherein the means for altering the sensitivity of the touch screen is configured to alter a capacitance of the touch screen.

28. The apparatus of claim 19, wherein the amount of the future noise is estimated based on at least one of a supply regulator noise, a use noise, a use-environment noise, a processing performance noise, or a display noise.

29. The apparatus of claim 28, wherein the amount of the future noise is estimated based on the supply regulator noise, the supply regulator noise including a noise caused by at least one of a battery condition, a grounding condition, electrostatic discharge, electromagnetic interference, or an external electrical noise.

30. The apparatus of claim 28, wherein the amount of the future noise is estimated based on the use noise, the use noise including a noise caused by at least one of a touch-stability condition, a through-touch condition, or a touch-screen surface condition.

31. The apparatus of claim 28, wherein the amount of the future noise is estimated based on the use-environment noise, the use-environment noise including a noise caused by at least one of a temperature condition, a moisture condition, a lighting condition, an altitude, or an air quality condition.

32. The apparatus of claim 28, wherein the amount of the future noise is estimated based on the processing performance noise, the processing performance noise including a noise caused by at least one of real-time characteristics for touch screen processing or stability calibrations.

33. The apparatus of claim 28, wherein the amount of the future noise is estimated based on the display noise, the display noise including a noise caused by at least one of a reflective display, a non-emissive/transmissive display, or an emissive-luminescent display.

34. The apparatus of claim 19, wherein the means for altering the sensitivity of the touch screen is configured to alter the sensitivity further based on parameters of a touch manager and parameters of a display manager.

35. The apparatus of claim 34, wherein the parameters of the touch manager include a touch medium size and a touch window, and the parameters of the display manager include display specifications and display-content characteristics.

36. The apparatus of claim 19, wherein the future noise is generated by a display module, the touch screen being within the display module.

37. An apparatus for noise compensation in a touch screen, comprising:
a processing system configured to:
estimate an amount of future noise that can affect the touch screen; and
alter a sensitivity of the touch screen based on the estimated amount of the future noise.

38. The apparatus of claim 37, wherein to estimate the amount of the future noise, the processing system is further configured to:
determine a characteristic of an image displayed on the touch screen; and
estimate the amount of the future noise based on the determined characteristic of the displayed image.

39. The apparatus of claim 38, wherein the characteristic of the image includes at least one of a dynamicity of the image indicating a degree of motion in the image and content of the image.

40. The apparatus of claim 37, wherein the amount of the future noise is estimated for each of a plurality of regions in the touch screen, and the sensitivity of the touch screen corresponding to each of the plurality of regions is altered based on the amount of the future noise in each of the plurality of regions.

41. The apparatus of claim 37, wherein the sensitivity is altered when the estimated amount of the future noise is greater than a first threshold or less than a second threshold.

42. The apparatus of claim 41, wherein the sensitivity is increased when the estimated amount of the future noise is less than the second threshold and is decreased when the estimated amount of the future noise is greater than the first threshold.

43. The apparatus of claim 41, wherein the sensitivity is decreased when the estimated amount of the future noise is less than the second threshold and is increased when the estimated amount of the future noise is greater than the first threshold.

44. The apparatus of claim 37, wherein to alter the sensitivity of the touch screen, the processing system is further configured to decrease the sensitivity if the amount of the future noise increases and to increase the sensitivity if the amount of the future noise decreases.

45. The apparatus of claim 37, wherein to alter the sensitivity of the touch screen, the processing system is further configured to alter a capacitance of the touch screen.

46. The apparatus of claim 37, wherein the amount of the future noise is estimated based on at least one of a supply regulator noise, a use noise, a use-environment noise, a processing performance noise, or a display noise.

47. The apparatus of claim 46, wherein the amount of the future noise is estimated based on the supply regulator noise, the supply regulator noise including a noise caused by at least one of a battery condition, a grounding condition, electrostatic discharge, electromagnetic interference, or an external electrical noise.

48. The apparatus of claim 46, wherein the amount of the future noise is estimated based on the use noise, the use noise including a noise caused by at least one of a touch-stability condition, a through-touch condition, or a touch-screen surface condition.

49. The apparatus of claim 46, wherein the amount of the future noise is estimated based on the use-environment noise, the use-environment noise including a noise caused by at least one of a temperature condition, a moisture condition, a lighting condition, an altitude, or an air quality condition.

50. The apparatus of claim 46, wherein the amount of the future noise is estimated based on the processing performance noise, the processing performance noise including a noise caused by at least one of real-time characteristics for touch screen processing or stability calibrations.

51. The apparatus of claim 46, wherein the amount of the future noise is estimated based on the display noise, the display noise including a noise caused by at least one of a reflective display, a non-emissive/transmissive display, or an emissive-luminescent display.

52. The apparatus of claim 37, wherein the processing system is configured to alter the sensitivity of the touch screen further based on parameters of a touch manager and parameters of a display manager.

53. The apparatus of claim 52, wherein the parameters of the touch manager include a touch medium size and a touch window, and the parameters of the display manager include display specifications and display-content characteristics.

54. The apparatus of claim 37, wherein the future noise is generated by a display module, the touch screen being within the display module.

55. A computer program product, comprising:
a computer-readable medium comprising code for:
estimating an amount of future noise that can affect the touch screen; and
altering a sensitivity of the touch screen based on the estimated amount of the future noise.

56. The computer program product of claim 55, wherein the code for estimating the amount of the future noise comprises code for:
determining a characteristic of an image displayed on the touch screen; and
estimating the amount of the future noise based on the determined characteristic of the displayed image.

57. The computer program product of claim 56, wherein the characteristic of the image includes at least one of a dynamicity of the image indicating a degree of motion in the image and content of the image.

58. The computer program product of claim 55, wherein the amount of the future noise is estimated for each of a plurality of regions in the touch screen, and the sensitivity of the touch screen corresponding to each of the plurality of regions is altered based on the amount of the future noise in each of the plurality of regions.

59. The computer program product of claim 55, wherein the sensitivity is altered when the estimated amount of the future noise is greater than a first threshold or less than a second threshold.

60. The computer program product of claim 59, wherein the sensitivity is increased when the estimated amount of the future noise is less than the second threshold and is decreased when the estimated amount of the future noise is greater than the first threshold.

61. The computer program product of claim 59, wherein the sensitivity is decreased when the estimated amount of the future noise is less than the second threshold and is increased when the estimated amount of the future noise is greater than the first threshold.

62. The computer program product of claim 55, wherein the code for altering the sensitivity decreases the sensitivity if the amount of the future noise increases and increases the sensitivity if the amount of the future noise decreases.

63. The computer program product of claim 55, wherein the code for altering the sensitivity of the touch screen alters a capacitance of the touch screen.

64. The computer program product of claim 55, wherein the amount of the future noise is estimated based on at least one of a supply regulator noise, a use noise, a use-environment noise, a processing performance noise, or a display noise.

65. The computer program product of claim 64, wherein the amount of the future noise is estimated based on the supply regulator noise, the supply regulator noise including a noise caused by at least one of a battery condition, a grounding condition, electrostatic discharge, electromagnetic interference, or an external electrical noise.

66. The computer program product of claim 64, wherein the amount of the future noise is estimated based on the use noise, the use noise including a noise caused by at least one of a touch-stability condition, a through-touch condition, or a touch-screen surface condition.

67. The computer program product of claim 64, wherein the amount of the future noise is estimated based on the use-environment noise, the use-environment noise including a noise caused by at least one of a temperature condition, a moisture condition, a lighting condition, an altitude, or an air quality condition.

68. The computer program product of claim 64, wherein the amount of the future noise is estimated based on the processing performance noise, the processing performance noise including a noise caused by at least one of real-time characteristics for touch screen processing or stability calibrations.

69. The computer program product of claim 64, wherein the amount of the future noise is estimated based on the display noise, the display noise including a noise caused by at least one of a reflective display, a non-emissive/transmissive display, or an emissive-luminescent display.

70. The computer program product of claim 55, wherein the code for altering the sensitivity of the touch screen alters the sensitivity further based on parameters of a touch manager and parameters of a display manager.

71. The computer program product of claim 70, wherein the parameters of the touch manager include a touch medium size and a touch window, and the parameters of the display manager include display specifications and display-content characteristics.

72. The computer program product of claim 55, wherein the future noise is generated by a display module, the touch screen being within the display module.
